(19) United States
(12) Patent Application Publication
(10) Pub. No.: US 2024/0020713 A1
(43) Pub. Date: Jan. 18, 2024

(54) SYSTEMS AND METHODS FOR A SOCIAL ENGAGEMENT PLATFORM

(71) Applicant: ImpactWayv, Inc., New York, NY (US)

(72) Inventors: Benjamin S. Bernstein, New York, NY (US); George C. Dolatly, New York, NY (US); Michael P. Hoffman, Thornwood, NY (US); Daniel D. Rubino, Milford, CT (US)

(21) Appl. No.: 18/374,194

(22) Filed: Sep. 28, 2023

Related U.S. Application Data
(63) Continuation of application No. 17/120,231, filed on Dec. 13, 2020, now abandoned.
(60) Provisional application No. 63/050,496, filed on Jul. 10, 2020.

(51) Int. Cl. G06Q 30/0201; G06Q 50/00; G06F 16/9035; G06F 16/27

(52) U.S. Cl. CPC G06Q 30/0201; G06Q 50/01; G06F 16/9035; G06F 16/27

(57) ABSTRACT

A method for generating a social engagement metric based on engagement by a user with a post on a virtual newsfeed provided for that user on a social network platform, the method comprising creating a user database for each user of the platform, the user database containing a user's self provided information database, a virtual newsfeed database, the virtual newsfeed database containing a post database of posts provided or posted in said virtual newsfeed, a user post history database, a user post interaction history database and a user post interaction event database, wherein when a user interacts with a post the user is credited with a post interaction event, and when another user interacts with the user's post interaction event, that another user's interaction with the user and the another user are credited with a post interaction event.

### CROSS REFERENCE TO RELATED APPLICATIONS

This application is a continuation of U.S. patent application Ser. No. 17/120,231, filed Dec. 12, 2013, which claims the benefit of U.S. Provisional Application No. 63/050,496 filed Jul. 10, 2020, which are incorporated by reference herein.

### FIELD OF INVENTION

Social Networking

Creation of a novel social engagement metric and social currency, entitled “Impacts”, based on user social impact behavior;

Gathering and/or analysis and/or providing aggregated data derived from a novel social engagement metric based on user social impact interests and/or behavior to nonprofit and/or for-profit organizations;

Creation of a dynamically updated social impact “Marketplace” which provides Users with transparency into, and comparison capabilities of, tangible for-profit and nonprofit social impact metrics;

Predictive modeling based on analysis of data gathered from users across the ImpactWayv Platform, which utilizes a novel social engagement metric, i.e., “Impacts”, for use by nonprofit and/or for-profit organizations, to enable a given organization to make targeted decisions regarding social impact and corporate social responsibility communications activities undertaken by the organization;

Utilizing and applying a machine learning sentiment analysis algorithm to learn public sentiment exclusively in response to social impact and corporate social responsibility initiatives undertaken by nonprofit and/or for-profit organizations, shared across the ImpactWayv Platform;

Production of location-based content and/or information streams focused exclusively on social impact initiatives, inspiration and social good opportunities;

Generation of awareness, action and self-generating digital impact measurement of social good initiatives and related activities via impact-focused online content, opportunities and/or information with attached calls to action.

### BACKGROUND/PRIOR ART

Over the past decade, there has been considerable growth in a social movement known as effective altruism, a philosophy which encourages individuals to make altruism a central part of their lives and do as much good as possible, typically by contributing a fixed percentage of one's income to the world's best-performing aid and development organizations. One of the results of this movement is that it has led to a demand by the public for information about how charities perform, which, in turn, has incentivized both nonprofits and companies to demonstrate their performance in the social good sector.

Businesses today are acutely aware that it is essential for them to embrace and adopt purpose-driven and “doing-good” business principles in order to survive and flourish in the short and long term, because consumers are increasingly making their purchasing power known by supporting businesses that engage in social causes that are important to the customer.

Furthermore, individuals, on a personal level, are increasingly engaged with social causes, while still mindful of their limited resources, such as time and money.

There exist social networking sites, such as Facebook and Twitter, which allow varying degrees of interaction between the users, that allow users to share data with each other, such as articles of interest, memes, and links to events. However, there does not at present exist a major social networking platform focused solely on social impact “causes” that enables users to both make and track their impact on the platform in real time, thereby allowing them to effectively measure the impact of their time and resources on their community and the causes of interest to them.

The novel social engagement metric and social currency created by the present invention, called “Impact,” seeks to bridge the gap between individuals' desire to do social good and the limited resources any one person may have by providing the ability to track the positive “Impact” of posts, as defined by the number of people who have engaged in the chosen social impact-oriented call to action(s) of the posts. An Impact is generated and created when a User engages in a call to action made by another User to that User's network of friends and other Users. In the Preferred Embodiment, Wayv Visits, Organization and/or Wayv Follows, Invites, and Post Views are the methods by which a User may engage in calls to action or ways of spreading awareness around social good causes and topics. In the Alternate Embodiment, a call to action may be chosen from the options of “Give”, “Learn”, “Volunteer”, and “Share”.

While other apps have tracked the number of individual actions Users take relative to the social impact causes of interest to them, there are no known apps or platforms that track positive “Impact” of a User's engagement with a specific cause as a result of how often a User has caused other Users to also engage with that cause as a result of their posts on the Platform. Both the ability to track the “Impact” by individual post, and cumulatively for each User on the Platform over time, is also completely unique. The method and system of the present invention democratizes the ability of users to impact others across their favorite causes by using technology and a social networking platform. Users work with their own network of other Users on the Platform to amplify the attention given to causes of interest and can track, in real time, the nature and extent of the engagement with their posts, both on the Platform and on other applications or platforms. The preferred embodiment for the present invention is described herein.

### SUMMARY OF THE INVENTION

An objective of the present invention is to provide a method for generating a social engagement metric based on engagement by a user with a post on a virtual newsfeed provided for the user on a social network platform, the method comprising creating a user database for each user of the platform, the user database containing a user's self provided information database, a virtual newsfeed database, the virtual newsfeed database containing a post database of posts provided or posted in said virtual newsfeed, a user post history database, a user post interaction history database and a user post interaction event database, wherein when a user interacts with a post on the user's virtual newsfeed, the interaction by the user with the post is logged in the post database for that post, the user's post interaction history database and the user's post interaction event database and the user is credited with a post interaction event in the user's post interaction event database, and when another user interacts with the user's post interaction event, that another user's interaction with the user's post interaction event is logged in the post database for that post, the another user's post interaction history database and the another user's post interaction event database, and the user and the another user are credited with a post interaction event in their respective post interaction event databases, and wherein the post interaction event by the another user is the social engagement metric, wherein a sum of the credits in any user's post interaction event database is used to determine that user's cumulative social engagement on the platform.

Another objective of the present invention is to provide a method for generating a lookalike user profile from a social engagement metric based on engagement by a user with a post on a virtual newsfeed provided for that user on a social network platform, the method comprising creating a user database for each user of the platform, the user database containing a user's self provided information database, a virtual newsfeed database, the virtual newsfeed database containing a post database of posts provided or posted in the virtual newsfeed, a user post history database, a user post interaction history database and a user post interaction event database, wherein when a user interacts with a post on the user's virtual newsfeed, the interaction by the user with the post is logged in the post database for that post, the user's post interaction history database and the user's post interaction event database and the user is credited with a post interaction event in the user's post interaction event database, and when another user interacts with the user's post interaction event, that another user's interaction with the user's post interaction event is logged in the post database for that post, the another user's post interaction history database and the another user's post interaction event database, and the user and the another user are credited with a post interaction event in their respective post interaction event databases, and wherein the post interaction event by the another user is the social engagement metric, wherein a sum of the credits in any user's post interaction event database is used to determine that user's cumulative social engagement on the platform, wherein the user's self provided information database and the user's post interaction event database are queried to generate the lookalike user profile.

A further objective of the present invention is to provide a method for disseminating information, the method comprising creating a social network platform, the platform containing a virtual newsfeed for a user of that platform creating a user database for each user of the platform, the user database containing a user's self provided information database, a virtual newsfeed database, the virtual newsfeed database containing a post database of posts provided or posted in the virtual newsfeed, a user post history database, a user post interaction history database and a user post interaction event database, wherein when a user interacts with a post on the user's virtual newsfeed, the interaction by the user with the post is logged in the post database for that post, the user's post interaction history database and the user's post interaction event database and the user is credited with a post interaction event in the user's post interaction event database, and when another user interacts with the user's post interaction event, that another user's interaction with the user's post interaction event is logged in the post database for that post, the another user's post interaction history database and the another user's post interaction event database, and the user and the another user are credited with a post interaction event in their respective post interaction event databases, and wherein the post interaction event by the another user is the social engagement metric, wherein a sum of the credits in any user's post interaction event database is used to determine that user's cumulative social engagement on the platform, wherein the user's self provided information database and the user's post interaction event database are queried to generate the lookalike user profile, and wherein the generated lookalike profiles are used to disseminate information to a selected group of users.

A method for producing location-based content and/or information streams, said method comprising creating a user database for each user of the platform, the user database containing a user's self provided information database, a virtual newsfeed database, the virtual newsfeed database containing a post database of posts provided or posted in the virtual newsfeed, a user post history database, a user post interaction history database and a user post interaction event database; wherein when a user interacts with a post on the user's virtual newsfeed, the interaction by the user with the post is logged in the post database for that post, the user's post interaction history database and the user's post interaction event database and the user is credited with a post interaction event in the user's post interaction event database, and when another user interacts with the user's post interaction event, that another user's interaction with the user's post interaction event is logged in the post database for that post, the another user's post interaction history database and the another user's post interaction event database, and the user and the another user are credited with a post interaction event in their respective post interaction event databases, and wherein the post interaction event by the another user is the social engagement metric, wherein a sum of the credits in any user's post interaction event database is used to determine that user's cumulative social engagement on the platform, wherein the user's self provided information database and the user's post interaction event database are queried to determine the user's geolocation and subsequently providing to the user's newsfeed posts that are specific to the user's geolocation and interests.

An additional objective of the present invention is to provide systems for executing the methods of the invention.

### BRIEF DESCRIPTION OF THE DRAWINGS

FIG. 1 is an overview of the components of the platform of the present invention;

FIG. 2 is a screenshot of the Sign In screen for the ImpactWayv platform;

FIG. 3 is a screenshot of the Individual Sign Up screen for the ImpactWayv Platform;

FIG. 4 is a flowchart depicting the Sign In process for both Registered and New Users for the ImpactWayv platform;

FIG. 5 is a screenshot of the About Me page of the ImpactWayv Platform;

FIG. 6 is a screenshot of a User's My Impact page;

FIG. 7 is an alternate screenshot of a User's My Impact page;

FIG. 8 is a flowchart depicting generation of an Impact;

FIG. 9 is a depiction of the generation of Impacts on pages of all Users engaged with a Post;

FIG. 10 is a screenshot of the “Give” Impact option;

FIG. 11 is a screenshot of the “Learn” Impact option;

FIG. 12 is a screenshot of the “Volunteer” Impact option;

FIG. 13 is a screenshot of the My Community page of the ImpactWayv Platform;

FIG. 14 is a screenshot of the Inspire-Featured page of the ImpactWayv Platform;

FIG. 15 is a screenshot of the Inspire-Featured page with an engagement with a Call to Action on the ImpactWayv Platform;

FIG. 16 is a screenshot of the Inspire-Following page of the ImpactWayv Platform;

FIG. 17 is a screenshot of the Inspire-Near Me page of the ImpactWayv Platform;

FIG. 18 is a screenshot of the Inspire-Near Me page sorted by Impacts;

FIG. 19 is a screenshot of the Marketplace-Nonprofits page of the ImpactWayv P;

FIG. 20 is a screenshot of the Marketplace-Companies page of the ImpactWayv Platform;

FIG. 21 is a screenshot of the Marketplace Profile page of the ImpactWayv Platform;

FIG. 22A-D is a chart of potential uses for the data gathered using the ImpactWayv Platform;

FIG. 23 is a flowchart depicting an embodiment of the method used to analyze the data gathered by the ImpactWayv Platform;

FIG. 24 is a flowchart depicting the data service flow for Impacts.

### DEFINITIONS

CSR: Corporate Social Responsibility;

ESG: Environmental, Social, and Governance;

Impact: the engagement by a User with a call to action made by another User to that User's network of friends and other Users including the options to “Give”, “Learn”, “Volunteer”, and “Share”;

Platform: the ImpactWayv social networking application;

Subscriber: an individual, group or business either participating on, or desiring data gathered from, the Platform; data may be raw or parsed, depending on the Subscriber's preference;

User: an individual, group or business visiting and participating in the Platform's digital community.

### DETAILED DESCRIPTION OF THE PREFERRED EMBODIMENT(S)

### (A) Creation of a Novel Social Engagement Metric and Social Currency, Entitled “Impact”.

The present invention is for a method and system for creating a new social engagement metric, and gathering and analyzing data based on that metric from a social networking application, entitled ImpactWayv, and social impact behavioral predictive modeling utilizing such data.

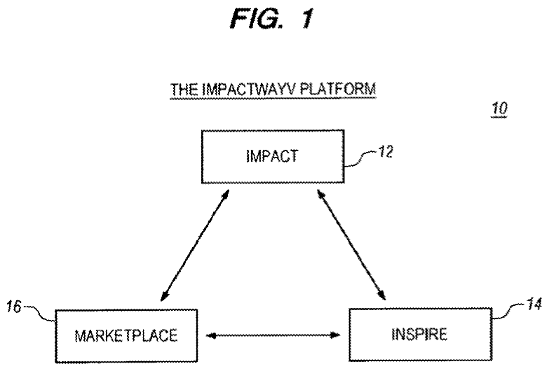

With reference to FIG. 1, the present invention provides a Platform 10 for individuals and corporations, both nonprofit and for profit, to interact with, engage in and take action related to causes that are of interest to them. For an individual, the Platform 10 is an application that consists of three main components, the “Impact” section 12, “Inspire” section 14 and “Marketplace” section 16, in order to generate the novel social engagement metric and social currency called an “Impact”.

### My Impact Page

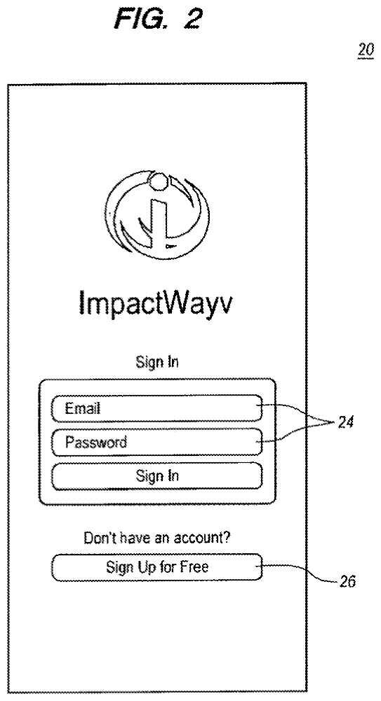

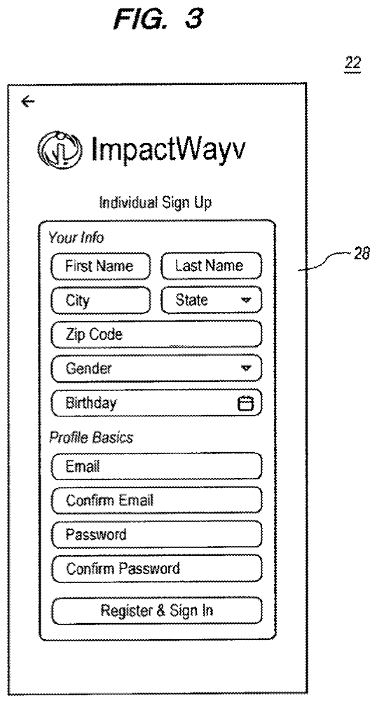

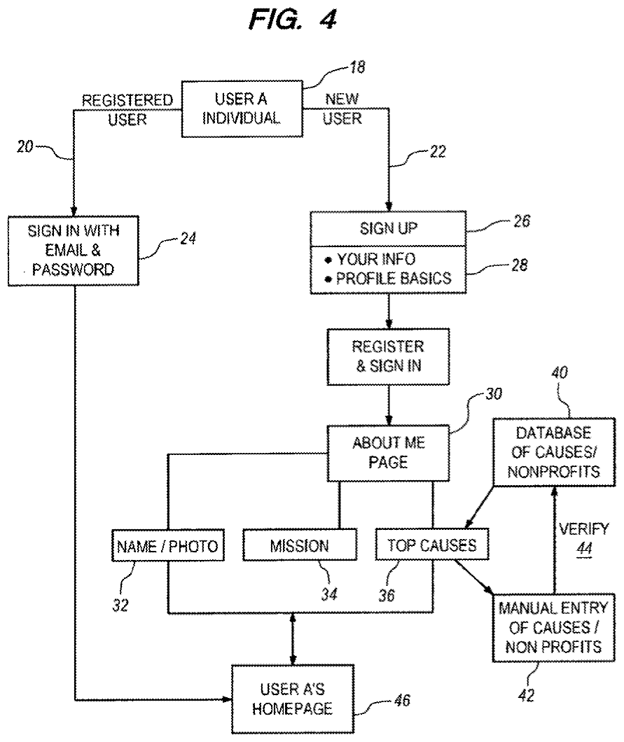

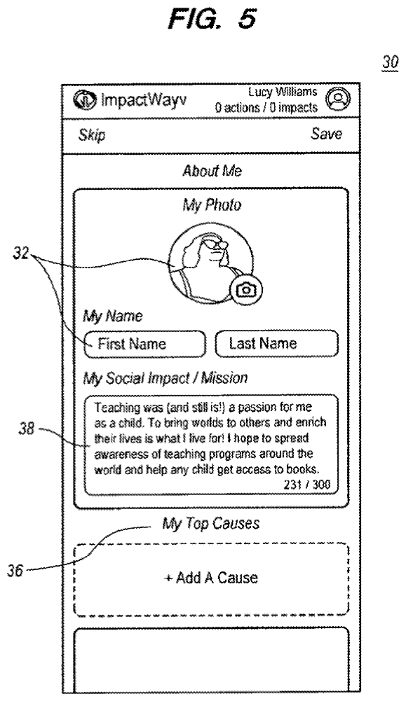

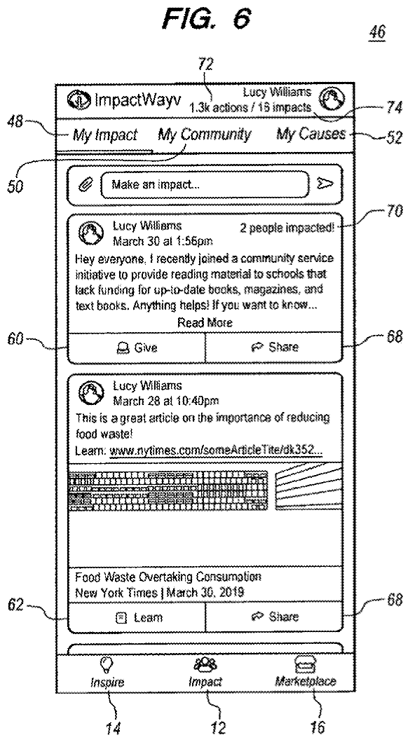

The My Impact Page 48, a subsection of the “Impact” section 12, is an individual User's homepage and is the screen to which they are directed immediately upon signing in. With reference to FIGS. 2-4, in order to begin utilizing the Platform 10, the User will use the Sign In screen to login to the Platform 10. For example, and with reference in particular to FIG. 4, User A 18 will log on to the Platform 10 either as a Registered User 20 or a New User 22. A Registered User 20 will use their Email and Password 24 as previously entered and verified to access the Platform 10. New Users 22 will utilize a SignUp 26 tab to access the Platform 10 and will complete the Your Info and Profile Basics inputs 28 to set up an account with a valid email and entering a password of their choice as commonly known and customarily done in the industry. Once they finish setting up an account, the User 18 will then be directed to an About Me page 30, see FIGS. 4, 5 and 6, where they will begin to customize their ImpactWayv account. This will allow the User 18 to enter their name and/or a photo 32, include a personalized mission statement 34 and choose the causes 36 of interest to them. The personalized mission statement 34 is entered using the “My Social Impact/Mission” input button 38 and allows the User 18 to inform others of their interests and any other personal information they believe to be useful or interesting to post. In addition, on the About me page, the User 18 will be able to choose to follow and/or include particular Causes and/or Nonprofits 36 that interest them in order to receive news, updates or information about those Causes and from those Nonprofits. These Causes 36 may be chosen from previously uploaded and available causes from the Database of Causes/Non-Profits 40. A User may upload a Cause or Nonprofit not included in the Database of Causes/NonProfits, and these will be independently verified prior to being available to that User on their list of Causes/Nonprofits. For an individual User 18, once the User's profile 30 is created, the User will be directed to their Homepage 46, as depicted in FIG. 6. The Homepage 46 is comprised of three separate sections of the Platform 10, “Inspire” 14, “Impact” 12 and “Marketplace” 16. The “Impact” 12 section further includes three separate subsections, specifically, “My Impact,” 48 “My Community,” 50 and “My Causes” 52.

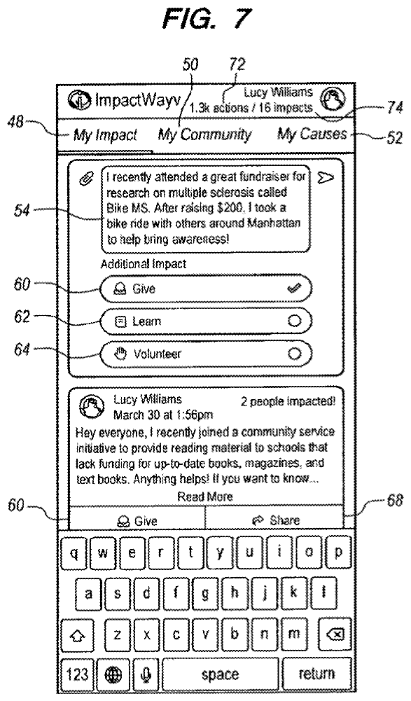

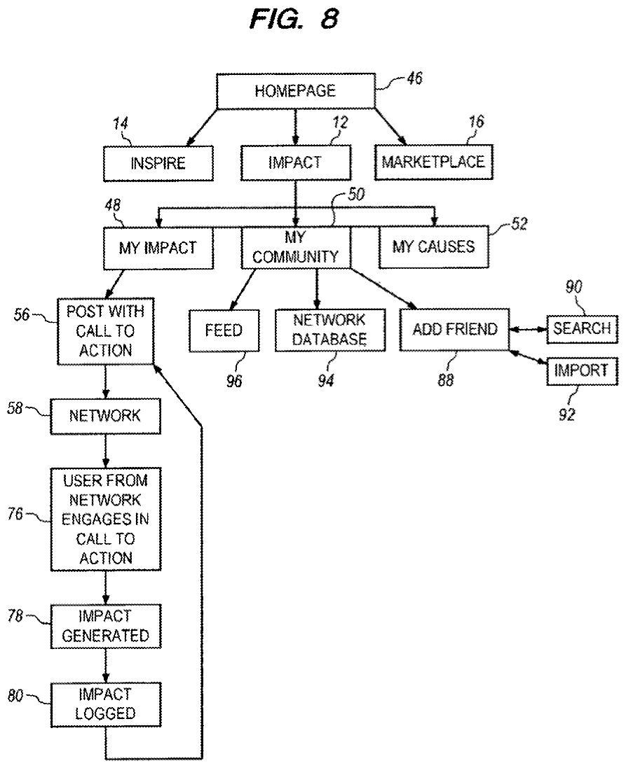

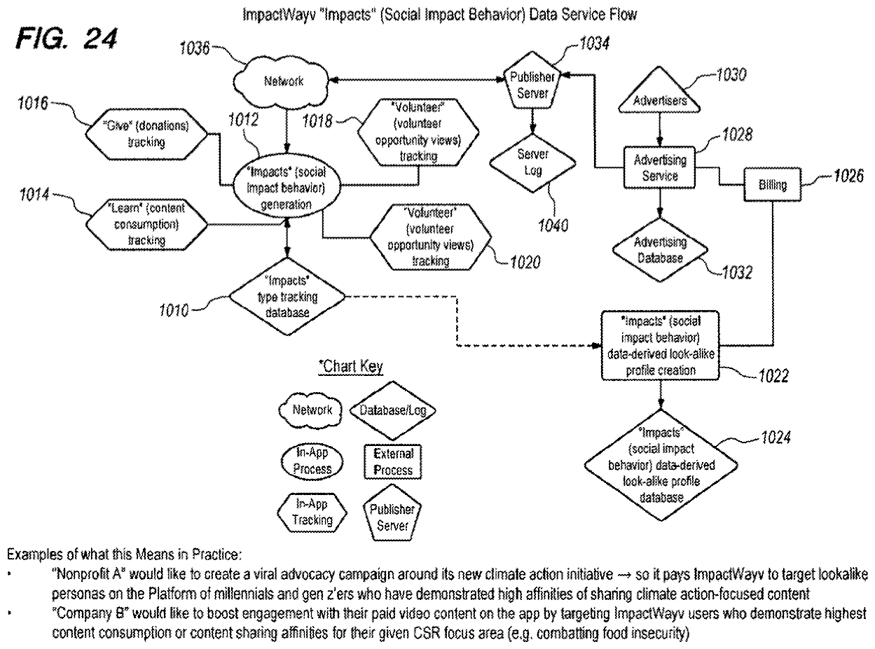

In order to generate an Impact 38, a User 18 will make a Post 54 under the section “Impact” 12, see FIGS. 7 and 8. Following this, the User 18 will send out the Post 54 with a Call to Action 56 to their Network of Friends 58 for that particular Post 54 by clicking on the appropriately labeled tabs on the screen. The particular Calls to Action 56 that a User 18 can make include, “Give” 60 (to a selected nonprofit), “Learn” 62 (about the cause in the post, through a linked article or other piece of content that the User pastes the link to in the post), “Volunteer” 64 (by visiting a volunteer opportunity link with a relevant nonprofit, that the User selects), or the default option of “Share” 68 (to simply share the User's post with other Users in the viewing User's own personal network on the Platform). When another User from User A's 18 network of friends 58 engages in a Call to Action 56 posted 54 by User A 18, an Impact is generated 76. This Impact is logged 78 in the Impacts tracking database 1010, see FIG. 24.

As can be seen in FIGS. 6 and 7, the User has made a Post 54 regarding a community service initiative they joined and requested that other Users “Give” 60 and/or “Share” 68 in response to this Post. Also, the User has made another Post linking an article on the importance of food waste and requested that other Users “Learn” 62 and/or “Share” 68. With reference to the Post regarding community service, it may be noted that the Post indicates “2 people impacted” 70. This allows the User 18 to know exactly how many people have engaged in their Call(s) to Action 56. Moreover, at the top of every page, under the User's profile name, the User 18 is able to see how many total actions 72 they have taken and the total number of impacts 74 they have made. This allows a User to measure and understand the impact of their Calls to Action 56 in a robust way. For the individual user, this is the most significant aspect of the Platform 10 of the present invention, in that it provides the User 18 with clear data regarding engagement of their community with their Calls to Action 56.

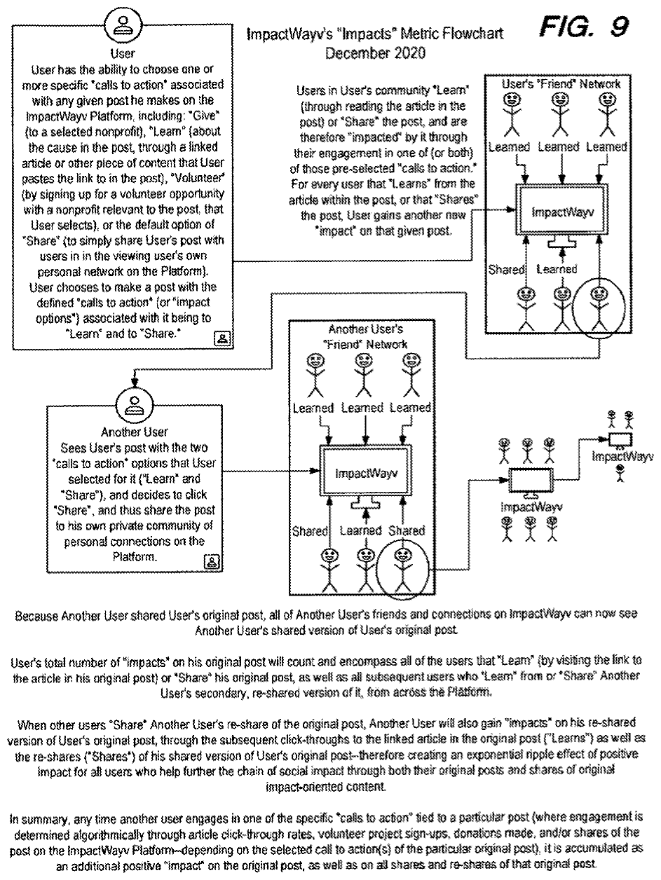

With reference to FIG. 9, whenever any User engages in any of the specific Calls to Action 56 tied to a particular Post 54, it generates an additional positive “Impact” 78 on the original Post 54, as well as on all shares and re-shares of that original Post 54. This positive, impact-driven feedback further inspires the User 18 to continue posting and sharing impact-oriented and inspiring content on the Platform 10 and results in continuing to move other Users to take action 76.

The engagement of User B with the Call to Action 42 is determined algorithmically through article/content click-through rates, volunteer project link visits, donations made, and/or shares of the post on the ImpactWayv Platform 10, depending on the selected call(s) to action of the particular original post.

In order to illustrate with further specificity the manner in which the posting framework of the ImpactWayv Platform functions, the following provides additional detail of the method by which a User would choose the particular “Impact options” for their post.

### 1. “Give” Impact Option

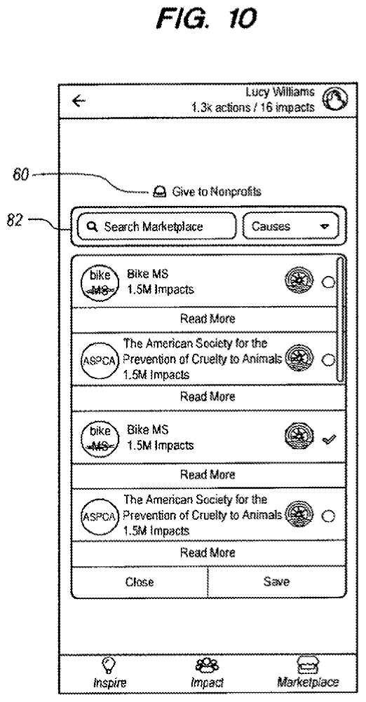

With reference to FIG. 10, if the User wants to select the “Give” 60 Impact option for a given post 54, a pop-up menu 82 will be displayed that enables the User to search the “Marketplace” of all registered 501(c)(3) nonprofit organizations listed on the Platform. The User will be able to filter them by cause category, if desired. The nonprofit that the User selects will then become the recipient of all donations made through that particular post by other Users.

### 2. “Learn” Impact Option

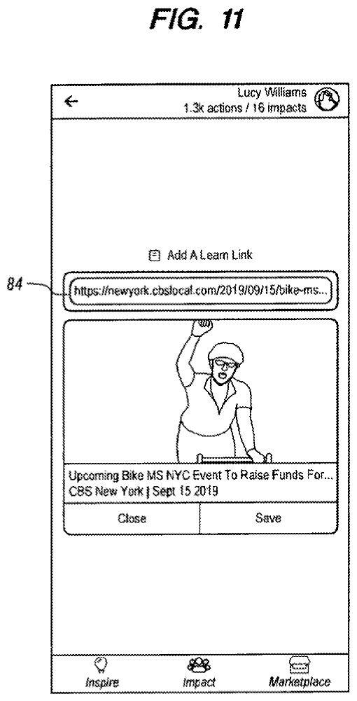

With reference to FIG. 11, if a User wants to select the “Learn” 62 Impact option for a given post 54, they will be prompted to paste a link 84 to any type of multimedia content, such as an article, a video, or an infographic, that helps educate other Users about interesting impact opportunities, learnings, or developments within the particular cause area of focus in the post (e.g. climate action, human services, community economic development, etc.). After the relevant content piece is pasted, and the post is submitted, whenever other Users click through to the piece of content attached to the post (by clicking “Learn” on the post), that particular “view” of the posted content by the other User will count and be tallied as an “Impact” of the post, because it is educating and/or inspiring users on the social impact cause area of focus.

### 3. “Volunteer” Impact Option

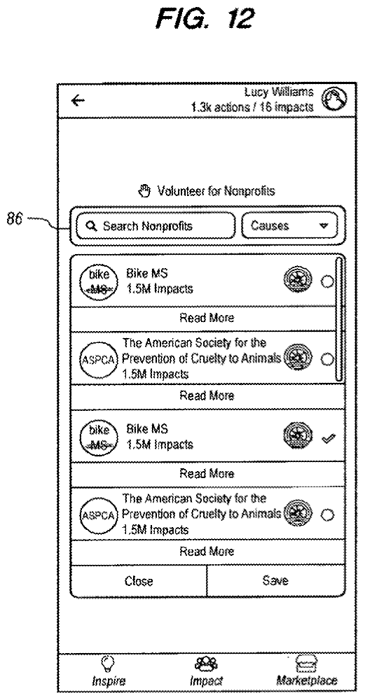

With reference to FIG. 12, if a User wants to select the “Volunteer” 64 Impact option, they will be met with an interface 86 that enables them to search and filter nonprofits on the Platform by cause category. They will be able to view a list of nonprofits with volunteering opportunities available in the near term for which they will be able to sign up and, also, share the selected volunteer opportunity with other Users. When another User clicks through to the volunteer opportunity selected as the given “Impact option” of the post made by the posting User, it will also count as a positive Impact on the posting User's post, because the posting User caused the viewing User to review and consider the volunteer opportunity, whether they sign up or not. Any User who shares or re-shares the volunteer opportunity posted by the original posting User will also receive a positive Impact on their shared or re-shared post for any other viewing User who clicks through to the volunteer opportunity through their shared/re-shared post (and in that case, the original User who first posted the shared volunteer opportunity will receive a positive Impact on their original post as well for every direct or indirect click through to the opportunity through their original link—creating a “ripple” effect of positive impact).

### My Community Page

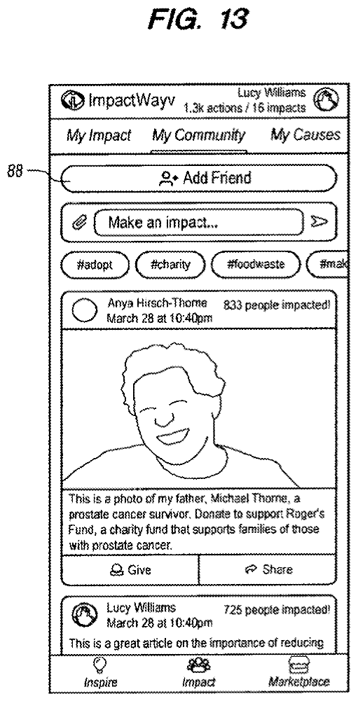

With reference to FIGS. 8 and 13, each User will also have a “My Community” 50 page, on which they will be able to scroll through all of the latest impact-oriented content from those that they are personally connected to on the Platform, and engage with posts accordingly, i.e., their “Feed” 96. The User 18 will, also, be able to add friends to their network of friends 58 on this page via the “Add Friend ” button 88. A User 18 may search 90 the Platform 10 for friends or import 92 friends from their contacts to join the Platform. These comprise the Network of Friends database 94.

### Inspire

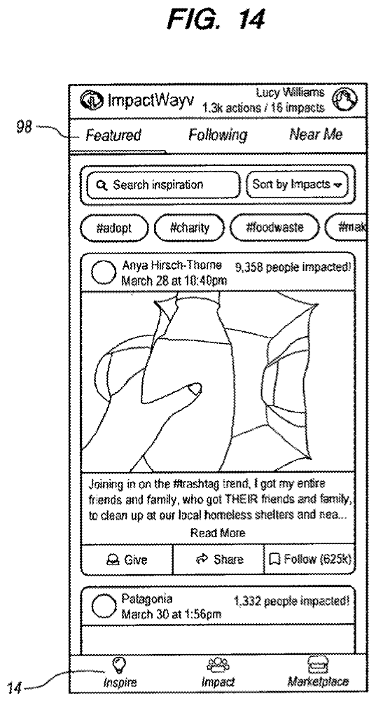

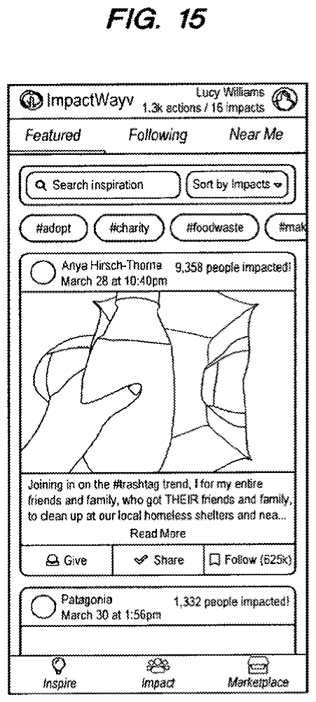

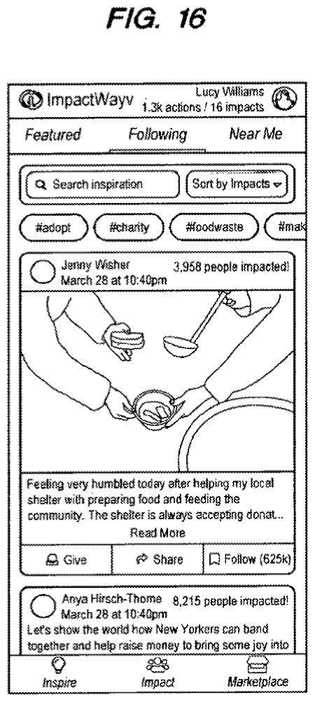

The Platform further includes an “Inspire” 14 section, which may be accessed via the “Inspire” navigation button at the bottom of each screen. Within the Inspire section's “Featured” page 98 , as shown in FIG. 14, users can scroll through engaging influencer, brand, and high impact user-generated content to gain inspiration from, education about, and engagement opportunities with, the cause areas they care about most. They can also engage directly with the “Impact options” or calls to action, see FIG. 15, associated with each post, as they would anywhere else on the Platform, and can choose to follow users, brands and organizations whose content they are interested in, as well, see FIG. 16.

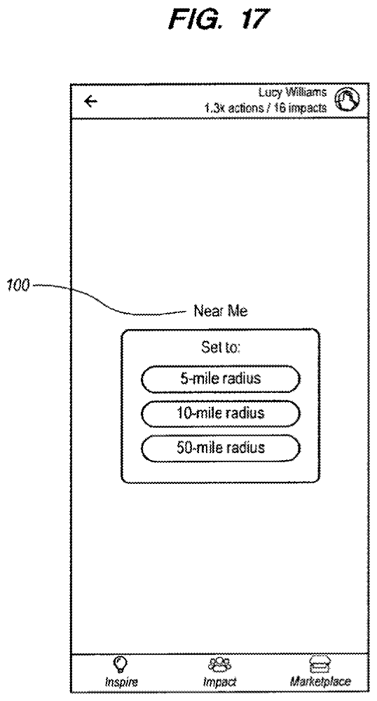

With reference to FIG. 17, by clicking on the “Near Me” 100 page in the “Inspire” section, Users will be met with the option of choosing the geographic radius within which they would like to see high impact content from across the ImpactWayv Platform. This feature is particularly unique, in that it provides a real time, completely targeted and location-based feed of the top trending social impact content and opportunities to take action within across a user's local geographic radius.

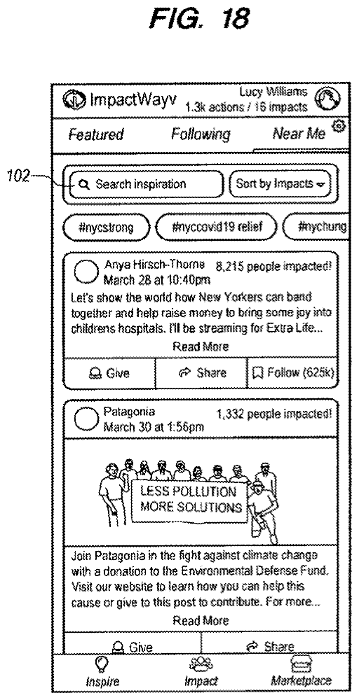

With reference to FIG. 18, a User may search for engaging social happenings 102 sorted by Impacts to retrieve a list of happenings with the most engagement by Users. This would give a User the opportunity to see a wide range of engaging social impact happenings and opportunities that are being posted and dynamically updated from across their local surroundings, with the ability to also filter the content/information stream by relevant cause area. This feature, for example, would enable Users in New York City, to see all of the top social impact content and opportunities that they could engage with or contribute to, filterable by trending cause area--which might include in the current moment, trending causes like “COVID-19 Relief,” “Black Lives Matter,” etc. This real time social impact-focused content, information and opportunity stream, when compared with other major social media platforms, would be differentiated in that it would contain only social impact-oriented content in nature, all of which would have built-in call(s) to action that can be carried out, amplified and measured within the self-contained ImpactWayv Platform itself. It would also enable Users to more adequately compare the respective impact (through the Platform's Marketplace of transparent information on social impact organizations—both nonprofit and for-profit) of the different social impact opportunities and initiatives available for them to engage with or contribute to in their geographic communities--all in one contained digital platform.

### Marketplace

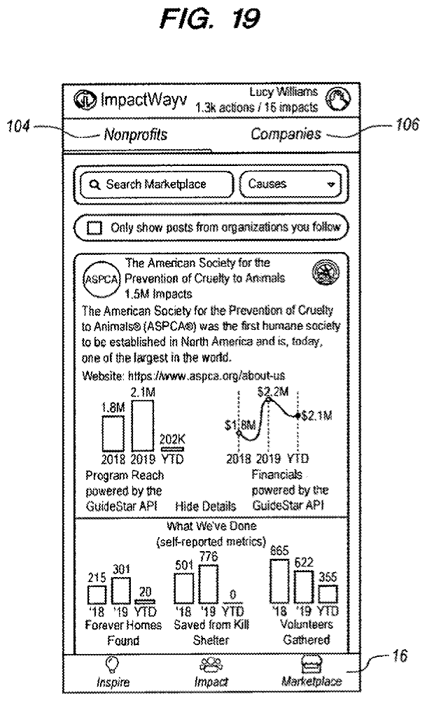

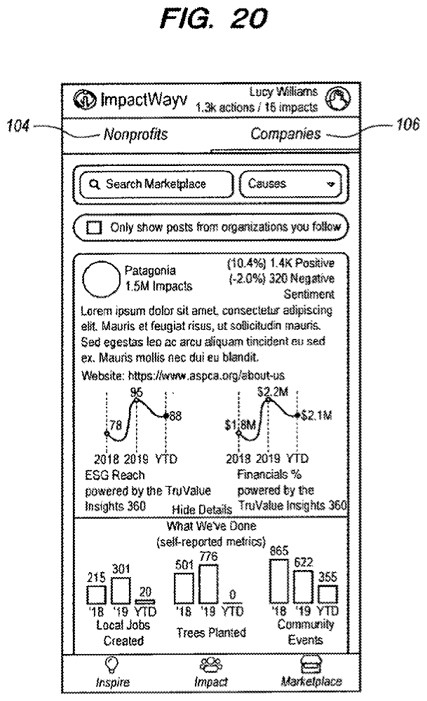

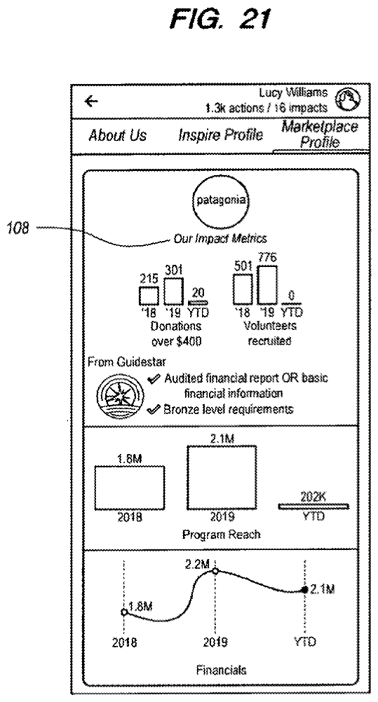

With reference to FIGS. 19 and 20, the “Marketplace” 16 section of the Platform 10 can be accessed via the “Marketplace” navigation button at the bottom of each screen and allows a User to access both nonprofit 104 and for-profit companies 106 that are included in the ImpactWayv Platform. This is the central impact information and data hub of the Platform, where nonprofits and for-profits can actively update their social impact and ESG metrics 108, see FIG. 21, and where individual users can seamlessly and transparently compare the societal impact work of these brands by category. Creating a Platform where businesses' paid content is exclusively focused on their social impact footprint and activities, and where nonprofits' impact metrics are transparently displayed to Users within a contained digital network and community focused on taking action around causes, at no cost to these nonprofit organizations, is a novel and unique concept.

Providing this for-profit and nonprofit impact information and data in one Platform, and empowering consumers/users of this Platform with the ability to compare, share and engage with these impact metrics of their favorite nonprofit and for-profit brands, together with friends and family members, will create a much more efficient, effective and informed “social impact sector” as a whole. With access to this type of information-all in one place-and the ability to compare and share the impact footprints of major brands and nonprofits with friends and family members on the Platform and outside of it by sharing it out to other applications, platforms or networks as well, Users will be able to greatly enhance the efficacy and efficiency of their social impact activities as a whole.

The “Companies” page in the Marketplace will provide data visualizations, scrollable comparison capabilities, and engagement opportunities for Users interested in getting a better understanding of the CSR, ESG, and overall corporate sustainability metrics of relevant brands, in a social networking setting that enables Users to easily post about, take action on, and respond to, the information they are accessing on these brands' impact footprints.

Both nonprofits and for-profits can actively update their social impact and ESG metrics, within organization profiles that individual Users can seamlessly access, and use to compare the societal impact work of these brands by category. Subscribing organizations that would like to edit their profiles in the Marketplace section of the Platform will have the opportunity to add their own customized, self-reported impact metrics via the “Add Metric” button, at their discretion.

Posts mentioning particular companies on the ImpactWayv Platform, all of which will be in response or in relation to their given corporate social responsibility initiatives and activities, will be analyzed using a machine learning trained sentiment analysis algorithm, with social impact-related sentiment analysis scores and trends for each company displayed within their respective profiles on the ImpactWayv Marketplace.

All interactions made by a User with organizations and companies on the Platform's “Marketplace”, as well as those made indirectly through the posts of other Users in the Impact and Inspire sections of the Platform, will be fully captured and displayed in the “My Causes” dashboard. This will enable the User to visualize the number of “Impacts” they have made on their favorite organizations and brands, by influencing others to do something positive for these organizations on the Platform. A User may also view the number of times they have individually acted to benefit the causes of these organizations (with these individual actions known on the Platform as “Actions”).

The above detailed method of creating the novel social engagement metric and social currency entitled “Impact” generates data which is available for analysis as desired, with a few examples as follows in section (B).

(B) Gathering and/or analysis and/or providing aggregated data derived from a novel social engagement metric based on user social impact behavior to nonprofit and/or for-profit organizations; Predictive modeling based on analysis of data gathered from users across the ImpactWayv Platform, which utilizes a novel social engagement metric, i.e.“Impacts”, for use by nonprofit and/or for-profit organizations, to enable a given organization to make targeted decisions regarding social impact activities undertaken by the organization.

The data collected via the Platform 10 and the Impact 38 may be particularized as self-provided data and Impact-generated data. Self-provided data means all data and information input by a User. Impact-generated data includes, but is not limited to, information regarding frequency of engagement with platform, specific time and dates for engagement with platform, location of user when engaging with platform, time of post, date of post, nature of posts, nature of calls to action, engagement with other user's posts and calls to action, and overlays of usage with geolocation services.

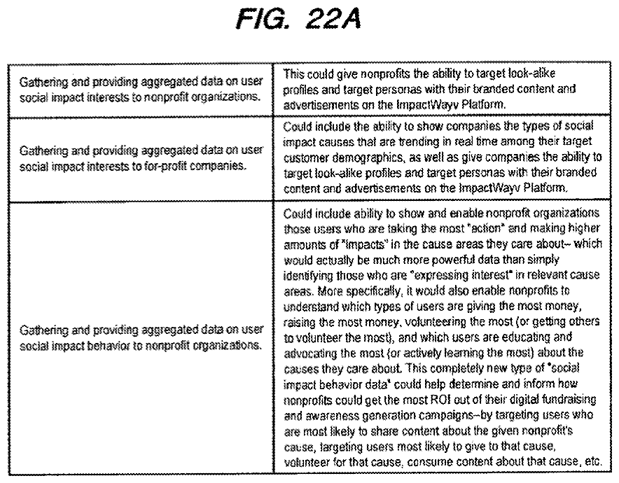

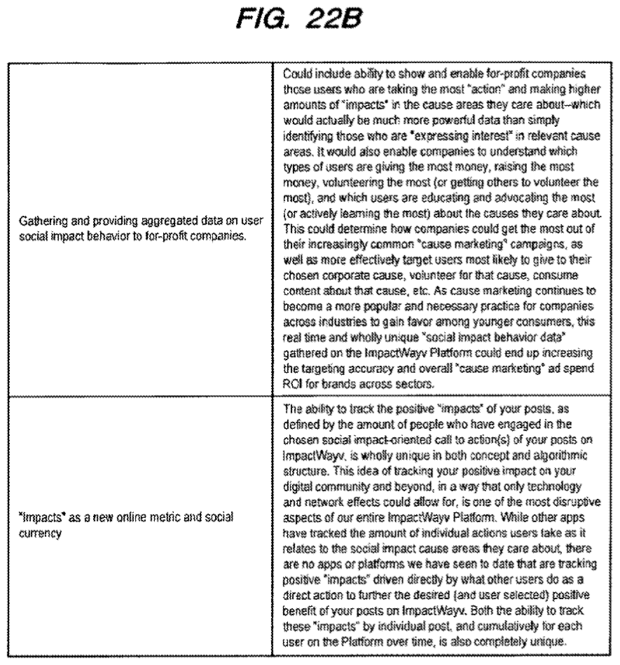

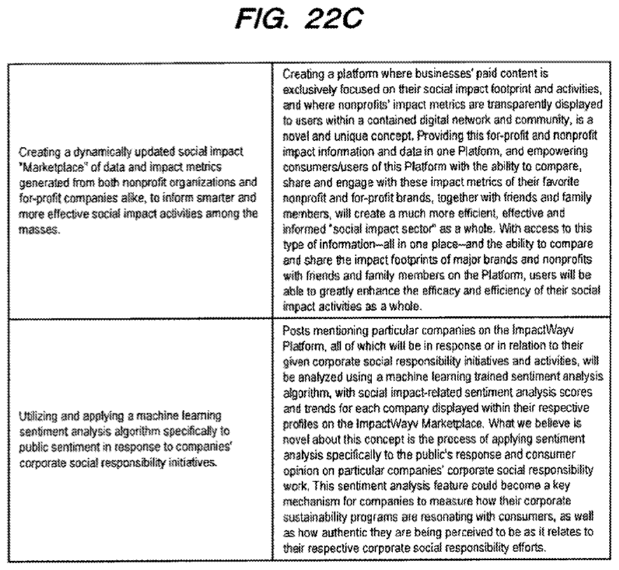

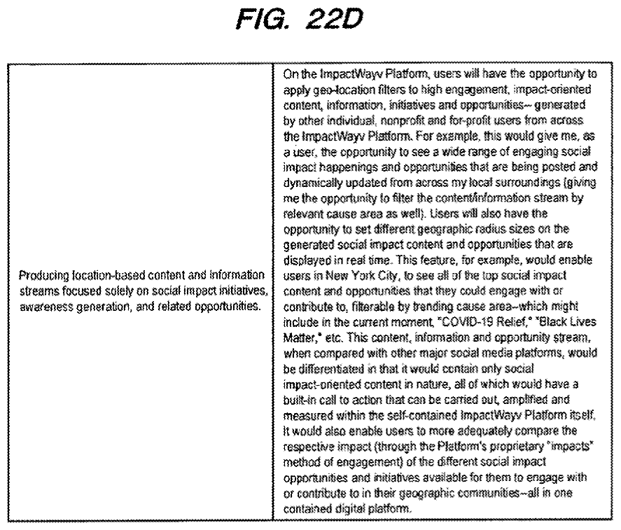

With reference to attached FIG. 22A-D, pages 1-4, below are some examples of the manner in which the data created via the Platform and derived from the Platform's central “Impact” metric, may be utilized.

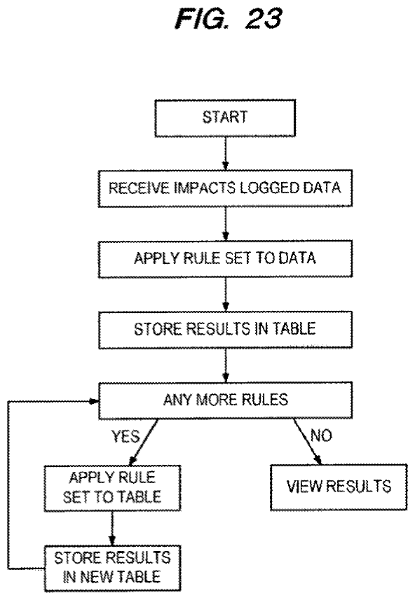

The data gathered by the method and system described in (a) is available to Subscribers for their customized preferences and may be analyzed as illustrated in FIG. 23, but any method for analysis may be used. For example, a Subscriber that is an organization, whether nonprofit or for-profit, may request data which enable it to identify “look-alike” profiles and sympathetic and/ or interested and/or potential Users and communicate their branded content and advertisements to these Users on the ImpactWayv Platform. In addition, the Impact data could demonstrate to for-profit companies the types of social impact causes that are trending in real time, and actually generating action among their target customer demographics. The holder and/or owners of the data generated by the ImpactWayv application would be able to parse the Impacts to provide the aggregated requested information to the Subscriber.

As another example, the Impact data could be used by for-profit companies to identify Users who are taking the most action and making the most Impacts in the cause areas of interest to the given company. This type of data is much more powerful and robust than data that simply identifies Users who express an interest in a cause. The Impact data would also enable both for-profit companies and nonprofits to understand which types of Users are giving and raising the most money, which types are interested in volunteering or encouraging others to volunteer, and which types are educating and advocating the most (or actively learning the most) about the causes of interest to them. Such information would assist companies and nonprofits in maximizing the effectiveness of their marketing campaigns, and help them in identifying and more precisely targeting Users most likely to give to their chosen corporate/organizational cause, volunteer for that cause, consume and share content about that cause, etc. As cause-centered marketing continues to become a more popular and necessary practice for companies across industries to gain favor among younger consumers, this real time and wholly unique “social impact behavior data” gathered on the ImpactWayv Platform would likely increase targeting accuracy and overall “cause marketing” ad spend ROI for brands across sectors.

In practice the above detailed description of the components of the ImpactWayv platform may be combined to produce the data service flow as shown in FIG. 24. To begin, and as an example, a nonprofit organization would like to create a viral advocacy campaign for its new climate action initiative and has requested the services of ImpactWayv to assist in this regard. The nonprofit has tasked ImpactWayv with targeting lookalike personas on the platform of millennial and Gen Z'ers who have demonstrated high affinity for sharing climate action-focused content. In order to accomplish this task, the ImpactWayv platform would query the “Impacts” tracking database 1010 for information about “Impacts” that have been generated by the users of the platform 1012. These Impacts that were generated 1012 may be “Learn” 1014, “Give” 1016, “Volunteer” 1018, or “Share” 1020 and are generated by the user each time they engage with the platform, as discussed previously. The results of the query, following the search of the database 1010 would be the creation of a lookalike profile 1022, as requested by the nonprofit. This profile, and others that match the request of the nonprofit, would be stored in the Impacts data derived look-alike profile database 1024. The nonprofit would be billed 1026 for the creation of the look-alike profile and subsequent advertising 1028 to the individuals in the look-alike profile database 1024. The advertising service 1028 is comprised of individual advertisers 1030 and services 1028 which are available in the advertising database 1032. Once the appropriate advertising service 1028 has been selected by the nonprofit, those advertisements are published to the network 1036 via the publishing server 1034. The publishing server maintains a server log 1040 for ease of tracking of the published advertisements.

While this invention has been particularly shown and described with references to preferred embodiments thereof, it will be understood by those skilled in the art that various changes in form and details may be made therein without departing from the spirit and scope of the invention.

1. A computer-based method of monitoring social impact of an entity on a social networking platform and generating a social impact metric based on the social impact by the entity, said method comprising:
publishing a first post from a first entity, the first post pertaining to a social cause;
storing the first post from the first entity in a post database;
issuing first social credits to the first entity for the first post and storing the social credits in a social credit database;
monitoring for one or more social impact events descendant from the first post by a second entity, the one or more social impact events including one or more of an interaction event, a donation event, a volunteering event, a sharing-of-a-post event, or a learning event;
issuing second social credits to the first entity for inducing the one or more social impact events by the second entity and storing the social credits in a social credit database;
issuing third social credits to the second entity for the one or more social impact events and storing the social credits in a social credit database;
generating a first social impact metric for the first entity as to the first cause, the first social impact metric being based on the first credits and the second credits;
generating a second social impact metric for the second entity as to the first cause, the second social impact metric being based on the third credits;
publishing the first impact metric in association with the first entity as to the first cause; and
publishing the second social impact metric in association with the second entity as to the first cause.

2. The method of claim 1, wherein the first entity is an individual.

3. The method of claim 1, wherein the first entity is a company.

4. The method of claim 1, further comprising identifying a look-alike entity with a similar social impact metric to the first social impact metric of the first entity.

5. The method of claim 1, further comprising producing location-based content associated with a geographic region, the location-based content configured to assist the first entity to identify the social cause or to assist the second user to identify the first post.

6. The method of claim 1, further comprising notifying a subject entity associated with the social cause when the one or more social impact events involving the social cause occurs.

7. The method of claim 1, further comprising notifying the first entity of the one or more first social impact events of the second entity.

8. The method of claim 1, further comprising rating the first entity and the second entity based on the first social impact metric and second social impact metric to identify the entity making greater impact on the social cause.

9. The method of claim 1, further comprising rating the first entity and the second entity based on the first social impact metric and second social impact metric to identify the entity making greater learning impact on the social cause.

10. The method of claim 1, further comprising rating the first entity and the second entity based on the first social impact metric and second social impact metric to identify the entity making greater volunteering impact on the social cause.

11. The method of claim 1, further comprising rating the first entity and the second entity based on the first social impact metric and second social impact metric to identify the entity making greater donation impact on the social cause.

12. The method of claim 1, further comprising rating the first entity and the second entity based on the first social impact metric and second social impact metric to identify the entity making greater sharing impact on the social cause.

13. The method of claim 1, further comprising identifying other entities associated with the social cause.

14. A computer-based system for monitoring social impact of an entity on a social networking platform and for generating a social impact metric based on the social impact by the entity, said system comprising:
one or more hardware processors; and
memory storing computer code that, when executed by the one or more hardware processors, causes the computer-based system to perform:
publishing a first post from a first entity, the first post pertaining to a social cause;
storing the first post from the first entity in a post database;
issuing first social credits to the first entity for the first post and storing the social credits in a social credit database;
monitoring for one or more social impact events descendant from the first post by a second entity, the one or more social impact events including one or more of a donation event, a volunteering event, a sharing-of-a-post event, or a learning event;
issuing second social credits to the first entity for inducing the one or more social impact events by the second entity and storing the social credits in a social credit database;
issuing third social credits to the second entity for the one or more social impact events and storing the social credits in a social credit database;
generating a first social impact metric for the first entity as to the first cause, the first social impact metric being based on the first credits and the second credits;
generating a second social impact metric for the second entity as to the first cause, the second social impact metric being based on the third credits;
publishing the first impact metric in association with the first entity as to the first cause; and
publishing the second social impact metric in association with the second entity as to the first cause.

15. The computer-based system of claim 14, wherein the computer code, when executed by the one or more hardware processors, causes the computer-based system further to perform identifying a related entity with a similar social impact metric to the first social impact metric of the first entity.

16. The computer-based system of claim 14, wherein the computer code, when executed by the one or more hardware processors, causes the computer-based system further to perform producing location-based content associated with a geographic region, the location-based content configured to assist the first entity to identify the social cause or to assist the second user to identify the first post.

17. The computer-based system of claim 14, wherein the computer code, when executed by the one or more hardware processors, causes the computer-based system further to perform notifying a subject entity associated with the social cause when the one or more social impact events involving the social cause occurs.

18. The computer-based system of claim 14, wherein the computer code, when executed by the one or more hardware processors, causes the computer-based system further to perform notifying the first entity of the one or more first social impact events of the second entity.

19. The computer-based system of claim 14, wherein the computer code, when executed by the one or more hardware processors, causes the computer-based system further to perform rating the first entity and the second entity based on the first social impact metric and second social impact metric to identify the entity making greater impact on the social cause.

20. The computer-based system of claim 14, wherein the computer code, when executed by the one or more hardware processors, causes the computer-based system further to perform rating the first entity and the second entity based on the first social impact metric and second social impact metric to identify the entity making greater learning impact on the social cause.

21. The computer-based system of claim 14, wherein the computer code, when executed by the one or more hardware processors, causes the computer-based system further to perform rating the first entity and the second entity based on the first social impact metric and second social impact metric to identify the entity making greater volunteering impact on the social cause.

22. The computer-based system of claim 14, wherein the computer code, when executed by the one or more hardware processors, causes the computer-based system further to perform rating the first entity and the second entity based on the first social impact metric and second social impact metric to identify the entity making greater donation impact on the social cause.

23. The computer-based system of claim 14, wherein the computer code, when executed by the one or more hardware processors, causes the computer-based system further to perform rating the first entity and the second entity based on the first social impact metric and second social impact metric to identify the entity making greater sharing impact on the social cause.

24. The computer-based system of claim 14, wherein the computer code, when executed by the one or more hardware processors, causes the computer-based system further to perform identifying other entities associated with the social cause.
